(19) United States
(12) Patent Application Publication
(10) Pub. No.: US 2020/0210695 A1
(43) Pub. Date: Jul. 2, 2020

(54) UTILIZING OPTICAL CHARACTER RECOGNITION (OCR) TO REMOVE BIASING

(71) Applicant: Capital One Services, LLC, McLean, VA (US)

(72) Inventors: Austin Grant WALTERS, McLean, VA (US); Vincent PHAM, McLean, VA (US); Alvin HUA, McLean, VA (US); Reza FARIVAR, McLean, VA (US); Jeremy Edward GOODSITT, McLean, VA (US); Fardin ABDI TAGHI ABAD, Champaign, IL (US)

(73) Assignee: Capital One Services, LLC, McLean, VA (US)

(21) Appl. No.: 16/238,320

(22) Filed: Jan. 2, 2019

(51) Int. Cl. G06K 9/00; G06F 17/24; G06F 17/27

(52) U.S. Cl. CPC G06K 9/00463; G06F 17/248; G06K 2209/01; G06F 17/2765; G06K 9/00456

(57) ABSTRACT

Various embodiments are directed to the removal of any biasing that may be present in a document. Portions of the document may be segmented into one or more boxes, each box containing content of the document. An OCR may be performed on each box, and text may be identified therein. It may be determined whether any of the text contains a biasing term. The biasing term may be deleted or may be replaced with a non-biasing term. A modified resume may be generated based on a standardized resume template. The modified resume may include only text, including the non-biasing terms, and exclude the biasing terms.

### BACKGROUND

Discriminatory practices within a company or business, whether intentional or unintentional, may be illegal and could expose the company to lawsuits and other types of legal issues. For example, an employee-recruiter, who is tasked with reviewing resumes, may be opposed to an applicant of a specific gender filling a specific position in the company due to a negative bias, and thus, may decline a resume containing a name (or other information) that indicates that gender. Other negative biases involving race, handicaps, languages, cultures, etc. may play a role in unfairly and discriminatorily rejecting an applicant. In some instances, positive biases may also be discriminatory, for example, accepting only applicants that have attended the employee reviewers alma mater. And in other instances, non-standard resumes from applicants with unique backgrounds, such as designers, may be unfairly declined due to ignorance bias because the resume is not in a standard resume format.

To prevent these types of biases, companies may require employees to undergo various types of anti-discrimination training. But training alone is only as good as its effectiveness, and even if the training is effective, it may not holistically prevent discriminatory behavior. Accordingly, there is a need for a more robust and efficient way of removing bias from company practices or the like.

### SUMMARY

Various embodiments are generally directed to the removal of any biasing that may be present in a document, such as a resume. Portions of the document may be segmented into one or more boxes, each box containing content of the document. An OCR may be performed on each box, and text may be identified therein. It may be determined whether any of the text contains a biasing term. The biasing term may be deleted or may be replaced with a non-biasing term. A modified resume may be generated based on a standardized resume template. The modified resume may include only text, including the non-biasing terms, and exclude the biasing terms.

### BRIEF DESCRIPTION OF THE DRAWINGS

FIG. 1 illustrates an example bias-removal platform in accordance with one or more embodiments.

FIG. 2 illustrates an example segmentation of a document in accordance with one or more embodiments.

FIG. 3 illustrates an example optical character recognition (OCR) on a document in accordance with one or more embodiments.

FIG. 4 illustrates an example deletion or replacement of biasing terms in a document in accordance with one or more embodiments.

FIG. 5 illustrates an example modified document generated based on a standardized template in accordance with one or more embodiments.

FIG. 6 illustrates an example flow diagram in accordance with one or more embodiments.

FIG. 7 illustrates an example computing architecture of a computing device in accordance with one or more embodiments.

FIG. 8 illustrates an example communications architecture in accordance with one or more embodiments.

### DETAILED DESCRIPTION

Various embodiments are generally directed to the removal of anything that might cause bias from a medium (e.g., paper-based, digital), such as text, images, formatting, or otherwise, by utilizing optical character recognition (OCR). The medium may be any document, such as a resume, a curriculum vitae (CV), etc., or may be a digital medium, such as a webpage, etc.

In examples, bias may be caused by a term (hereinafter referred to as a biasing term), an image (hereinafter referred to as a biasing image), and/or formatting (hereinafter referred to as a biasing format), which may collectively be referred to as “biasing.” In examples, biasing may be removed from the medium in various ways: by deleting the biasing terms or the biasing images from the medium, by replacing biasing terms with non-biasing terms, and/or by generating a modified medium that is formatted according to a standardized template.

In embodiments, one or more portions of the medium may be segmented into one or more boxes, each box containing content of the medium. OCR may be performed on each segmented box. For instance, during the OCR, directional searches (e.g., horizontal, vertical, diagonal) may be performed on the content of the boxes, which advantageously identifies, accounts for, or captures text or images that may be arranged at different angles in the medium. Using the OCR, all text in the medium may be identified and acquired for bias analysis. Moreover, images and other objects in the medium may be identified based on the OCR.

According to examples, the acquired set of text may be analyzed to determine whether there are any biasing terms. A biasing term, for instance, may directly or indirectly indicate a gender, a race, sexual orientation, socioeconomic status, etc. The determination of whether a biasing term is present may be performed by a classification model, which may be a logistic regression model, a decision tree model, a random forest model, a Bayes model, or any other suitable model. The classification model may be trained with training data that may include biasing terms that are not only common but also relevant to its application, e.g., for resumes—gender revealing names, words in organizations, clubs, or associations that reveal gender, hobbies that reveal gender or socioeconomic status, top universities that elicit positive biases, etc.

Upon determining a biasing term in the acquired set of text, the biasing term may be removed entirely, or it may be replaced with a non-biasing term, which may be, for example, a generic term that can adequately describe the biasing term without eliciting any bias. In embodiments, the acquired set of text, including the changes to the biasing terms (e.g., deletions, replacements), may be used to generate a modified medium based on a standardized template. In the resume example, a standardized resume template may arrange the text according to a standardized resume format. In alternative embodiments, the identified text in the medium itself may be deleted or replaced, thereby keeping the format of the original medium unchanged.

Previous solutions merely attempt to remove bias from humans themselves by way of training and other anti-discriminatory practices. In addition to training, previous solutions also attempt to utilize document parsing to automate (and to remove the human element out of some parts of) the review processes. While training is an important deterrence of discrimination, the previous solutions, however, rely on the hope or assumption that humans will behave perfectly. The embodiments and examples described herein overcome the above problems and are advantageous over the previous solutions in that the bias-source is either removed or altered from the medium itself, thereby “sterilizing” the medium of any bias-causing content prior to human review. Accordingly, overall fairness may be increased, and exposure to various types of legal and administrative issues may be minimized.

Reference is now made to the drawings, where like reference numerals are used to refer to like elements. In the following description, for the purpose of explanation, numerous specific details are set forth in order to provide a thorough understanding thereof. It may be evident, however, that the novel embodiments can be practiced without these specific details. In other instances, well-known structures and devices are shown in block diagram form to facilitate a description thereof. The intention is to cover all modification, equivalents, and alternatives within the scope of the claims.

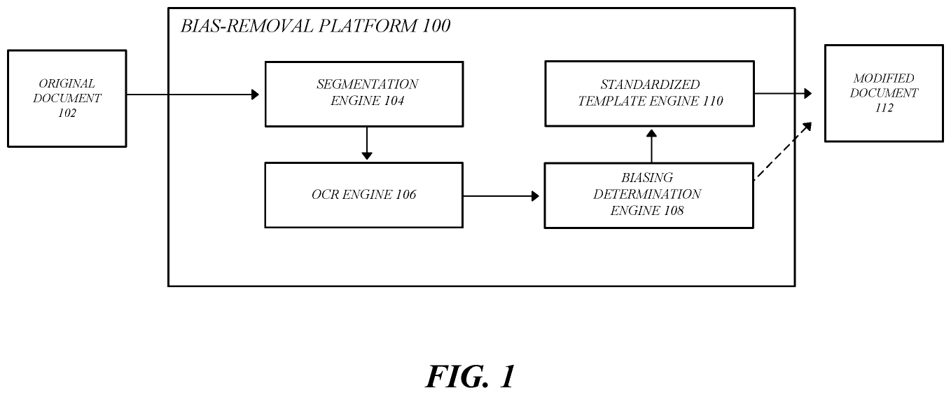

FIG. 1 illustrates an example bias-removal platform 100 according to one or more embodiments. As will be further discussed below, one or more computing devices, or processing circuitry thereof, may be operable to execute instructions that provide and support the bias-removal platform 100 and the various components therein.

By way of example, the bias-removal platform 100 may receive a medium, such as an original document 102, and output a modified document 112 that is stripped of any potential bias-causing content in the original document 102. As shown, the bias-removal platform 100 includes at least a segmentation engine 104, an OCR engine 106, a biasing determination engine 108, and a standardized template engine 110.

According to one embodiment, the original document 102, which may be a resume or CV, may be input to the bias-removal platform 100. The segmentation engine 104 takes one or more portions of the original document 102 and segments them into one or more boxes. As will be further described below, the boxes may contain various types of document content therein, which may be text, images, objects (digital or otherwise), etc. The OCR engine 106 then performs OCR on the content contained each box. The OCR process may involve conducting a horizontal search or scan, a vertical search or scan, and/or a diagonal search or scan on each segmented box to identify content that may arranged at varying angles. Via the OCR engine 106, all text in the original document 102 may be identified and/or acquired. Moreover, images and other objects may also be identified and acquired.

The biasing determination engine 108 receives at least the acquired set of text identified via the OCR engine 106 and performs analysis thereon to determine whether there are any biasing terms. In examples, the biasing determination engine 108 may include a classification model (e.g., a text classifier) to perform the biasing analysis on the text. As described above, the classification model may be a logistic regression model, a decision tree model, a random forest model, a Bayes model, or any other suitable classification model. Moreover, the classification model may be based on a convolutional neural network (CNN) algorithm, a recurrent neural network (RNN) algorithm, a hierarchical attention network (HAN) algorithm, or the like. Various types of training data may be used to train the classification model based on the type of the original document 102. For example, if the document is a resume, numerous terms that may directly or indirectly indicate gender, race, sexual orientation, culture, socioeconomic status, etc. may be used as the training set. Such terms may be “genderized” terms like a name associated with a specific gender, terms that contain the words “women,” “men,” or variations thereof, terms commonly associated with a gender like “football,” “shopping,” “knitting,” or terms that reveal race like “Asian,” etc.

According to embodiments, the biasing terms determined by the biasing determination engine 108 may be deleted entirely, or, may be replaced with a non-biasing term. As set forth above, a generic term that can adequately describe the biasing term without eliciting any bias. Moreover, the generic term may indicate that the biasing term has been removed by using the term “removed.” Thus, for example, the term “women's volleyball club” may be replaced with “volleyball club,” the term “Sally Doe” may be replaced with “Candidate #1,” or the term “baking” can simply be changed to “removed.”

Upon deleting and/or replacing all the biasing terms in the acquired set of text from the original document 102, a standardized template engine 110 may generate the modified document 112 according to a format specified by a standardized template. Referring again to the resume example, and as will be further described below, a standardized resume template may specify a format in which at least a biography section, an education section, an experience section, a skills section, an organization section, and an “other” section is arranged—in that order—from top to bottom. Thus, the standardized template engine 110 may arrange the text according to that format to generate a new document, which is the modified document 112. Alternatively, as shown in FIG. 1, the modified document 112 may not be new and may be the original document 102 that is altered to delete and/or replace all the biasing terms therein (and optionally delete all images and objects therein), as depicted by the dashed arrow, which allows the modified document 112 to retain the format of the original document 102.

In examples, the modified document 112 may contain only text and exclude all images and/or objects that were in the original document 102. In other examples, the biasing determination engine 108 may determine whether there are any biasing images in the original document and replace those images with non-biasing images. Thus, for images, the classification model may be an image classifier. A biasing image, similar to biasing terms, may directly or indirectly indicate gender, race, sexual orientation, culture, socioeconomic status, etc.

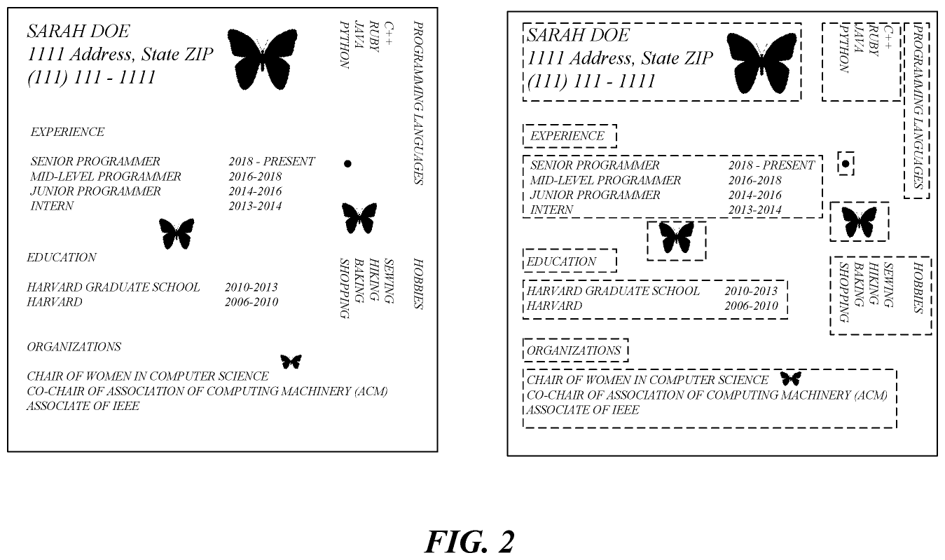

FIG. 2 illustrates an example segmentation of a document according to one or more embodiments. As shown on the left, the document may be a resume, which includes a biography section (e.g., Sarah Doe, address, phone number), an experience section, an education section, an organizations section, a programming languages section, and a hobbies section. In addition to text, the resume also includes four differently sized images of a butterfly and further includes an object (e.g., a dot) above one of the butterflies. Moreover, as further shown, the programming languages section and the hobbies section are rotated 90 degrees and arranged on the right-hand side of the resume.

In embodiments, one or more portions of the resume may be segmented. By way of example, the resume may be segmented into numerous boxes, as illustrated by the dashed boxes. For instance, the entire biography section and a butterfly may be bound by one box. The content of the experience section may be bound by a different box, the content of the entire hobbies section bound by yet another box, and so on.

It may be understood that the shown segmentation and the number and arrangement of the boxes, illustrated in FIG. 2 is not limited thereto. The number of boxes may vary based on the amount of content in the document and the way the boxes may enclose the content or how they are arranged may also vary accordingly.

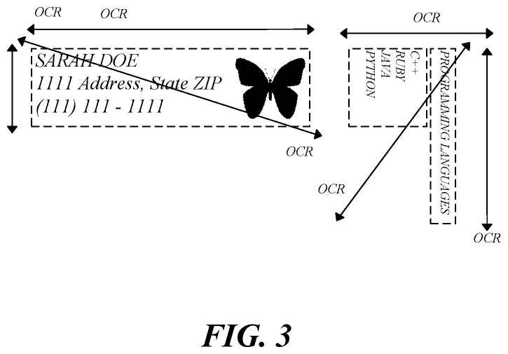

FIG. 3 illustrates an example optical character recognition (OCR) on a document according to one or more embodiments. The document may be a resume, and more specifically, it may be the resume illustrated in FIG. 2. As set forth above, OCR may be performed on the content contained in the one or more segmented boxes. By way of example, FIG. 3 shows OCR being performed on the content at the very top row of the resume of FIG. 2, which are bound by three separate boxes.

The OCR process may involve performing one or more directional OCR searches on the content contained in the boxes, such as a horizontal OCR search, a vertical OCR search, and a diagonal OCR search. For example, when the one or more OCR searches are performed on the left-most box, only the horizontal OCR search will produce hits on the text and the image. Since there are no vertically or diagonally arranged text or images, the vertical and diagonal OCR searches will not produce any hits. Based on this OCR process, the terms “SARAH DOE,” “1111 Address, State ZIP,” and “(111) 111-1111” may be identified for bias analysis. Moreover, in other examples, these terms may be identified, acquired, set aside, where the bias analysis may be performed later when all text has been identified in the document.

One or more OCR searches may also be performed on the two right boxes. In some examples, the OCR search may be performed on multiple boxes at the same time, if, for instance, the boxes are related to the same section in the document. Thus, the vertical OCR search on the two boxes will result in hits, whereas the horizontal and diagonal OCR searches will not. The terms identified in the vertical OCR search are “Programming Languages,” “C++,” “Ruby,” “Java,” and “Python.” Again, these terms may be identified for bias analysis.

It may be understood that the same type of OCR searches may be performed on all the boxes illustrated in FIG. 2. The text, images, objects, etc. identified in the OCR searches may be acquired and set aside for bias analysis. Advantageously, the different directional OCR searches all text or images arranged at different angles in the document to be identified, whereas traditional resume parsing techniques do not.

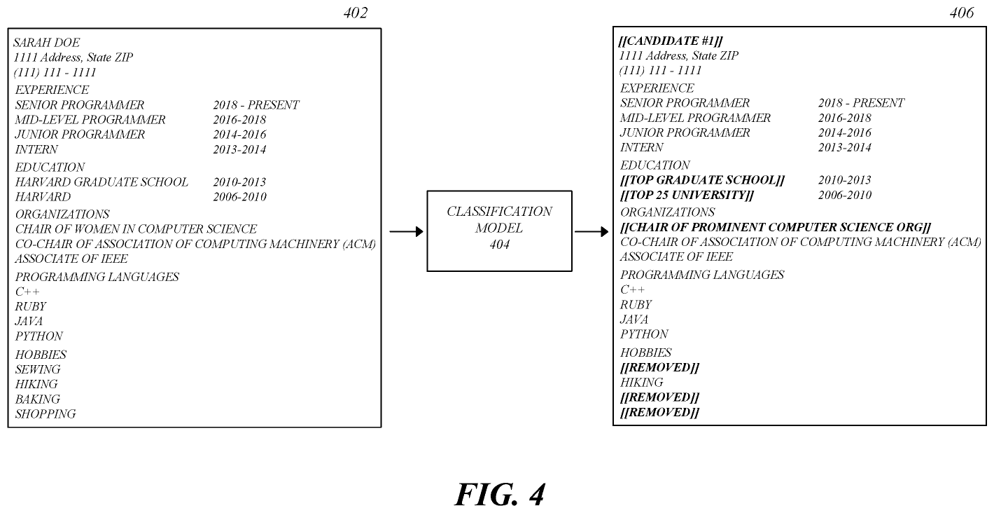

FIG. 4 illustrates an example deletion or replacement of biasing terms in a document according to one or more embodiments. As set forth above, the document may be a resume, such as the resume shown in FIG. 2. As shown, the process of deleting or replacing any biasing term involves first determining whether there are any biasing terms via a classification model 404. For instance, the acquired set of text 402 from the resume may be input to the classification model 404. As described above, the classification model 404 may be a logistic regression model, a decision tree model, a random forest model, a Bayes model, or any other suitable classification model, one or more of which may be based on a convolutional neural network (CNN) algorithm, a recurrent neural network (RNN) algorithm, a hierarchical attention network (HAN) algorithm, or the like.

Based on the bias analysis performed by the classification model 404, it may be determined that seven different terms from the acquired set of text 402 are biasing terms: “SARAH DOE,” “Harvard Graduate School,” “Harvard,” “Chair of Women in Computer Science,” “sewing,” “baking,” and “shopping.” The biasing terms may thus be deleted from the set or may be replaced with non-biasing terms. In the example shown, the biasing terms are replaced. For instance, the “genderized” term “SARAH DOE,” which is the applicant's name, may be changed to a “non-genderized” term such as “Candidate #1,” as shown by double brackets and in bold in box 406. The terms “Harvard Graduate School” and “Harvard,” which may elicit positive bias, may be replaced with “Top Graduate School” and “Top 25 University,” respectively. Similar to the term “SARAH DOE,” the term “Chair of Women in Computer Science” may elicit gender bias and may be replaced with the generic “Chair of Prominent Computer Science Org.” The terms “sewing,” “baking,” and “shopping,” all of which may also elicit gender bias may be replaced with the term “Removed.”

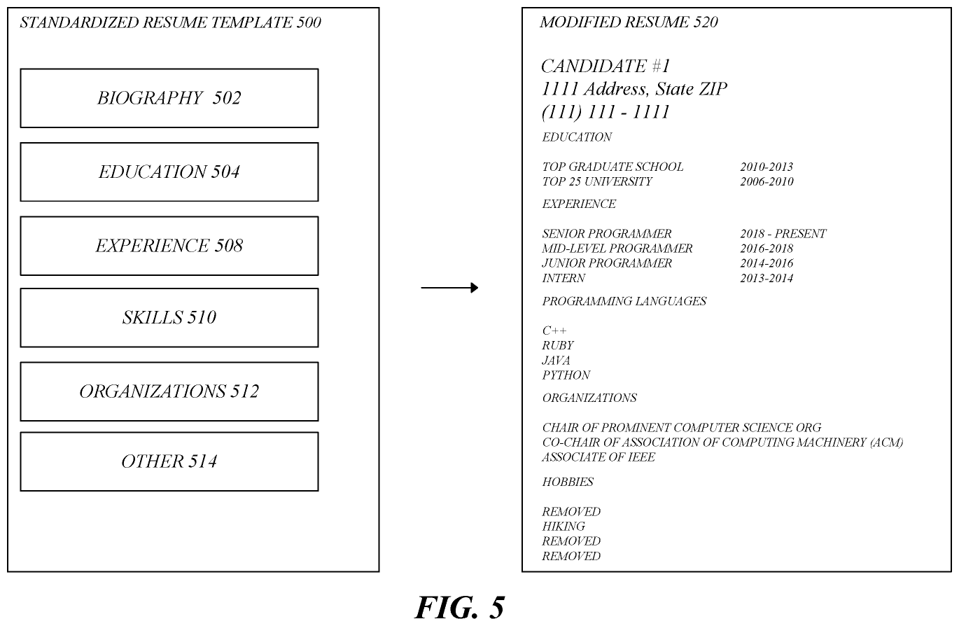

FIG. 5 illustrates an example modified document generated based on a standardized template according to one or more embodiments. The standardized template, for example, may be a standardized resume template 500. As shown, the standardized resume template 500 may include a biography section 502, an education section 504, an experience section 508, a skills section 510, an “organizations” section 512, and an “other” section 514, in that exact order. It may be understood that the specific format of the standardized template may be different for different purposes. The standardized resume template 500 has a format that removes any potential biasing resulting from uncommon or unique formats, such as a resume from a designer.

Accordingly, a modified resume 520 may be generated by arranging the modified text in box 406 of FIG. 4 according to the specified format of the standardized resume template 500. Thus, there is nothing in the modified resume 520 (text, images, objects, or otherwise) that may elicit bias from a reviewer.

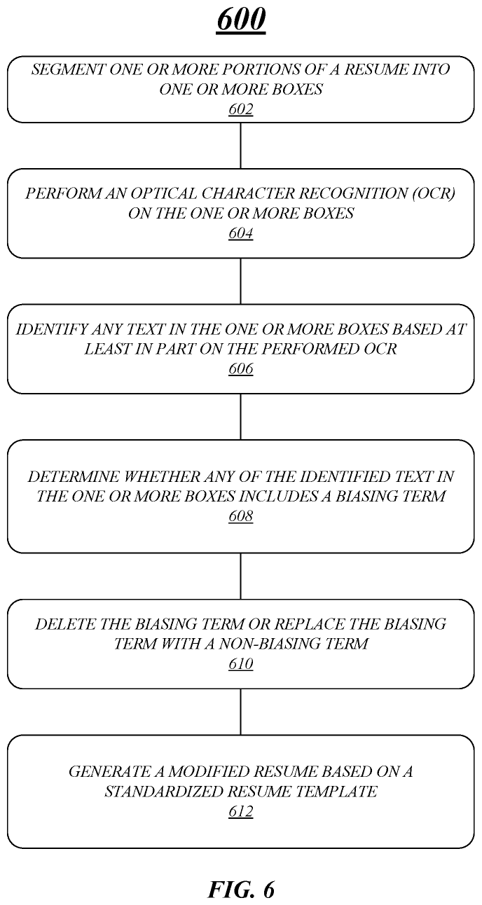

FIG. 6 illustrates a flow diagram 600 in accordance with one or more embodiments. The flow diagram 600 is related to the removal of biasing in a resume, but it may be understood that this process may be applied to any other suitable medium (document, webpage, etc.). It may be understood that the features associated with the illustrated blocks may be performed or executed by one or more computing devices and/or processing circuitry contained therein.

At block 602, one or more portions of a resume may be segmented into one or more boxes. Each segmented box may contain different content of the resume. For example, one box may contain content associated with the biography section; another box may contain content associated with the applicant's experience, and another associated with education, and so on.

At block 604, OCR may be performed on the one or more segmented boxes of the resume. As described above, the OCR may involve performing a horizontal, a vertical, and/or a diagonal OCR search on the content contained in the one or more boxes. At block 606, textual content may be identified in the one or more boxes based on the OCR performed at block 604. In some examples, images and other objects in the resume may also be identified.

At block 608, it is determined whether any of the identified text in the one or more boxes contain or include a biasing term. The determination may be based at least in part on the analysis performed by a classification model. The classification mode, as described above, may be trained with training data and/or terms that pertain to resume-related words that commonly elicit any negative, positive, or formatting bias.

At block 610, upon determining that the text contains a biasing term, the biasing term is either deleted completely or may be replaced with a non-biasing term. The non-biasing term may be a generic term that can adequately describe the biasing term without imparting any potential bias. And at block 612, a modified resume may be generated based on a standardized resume template, which may only include text and excludes all of the determined biasing terms and/or images.

It may be understood that the blocks illustrated in FIG. 6 are not limited to any specific order. One or more of the blocks may be performed or executed simultaneously or near simultaneously.

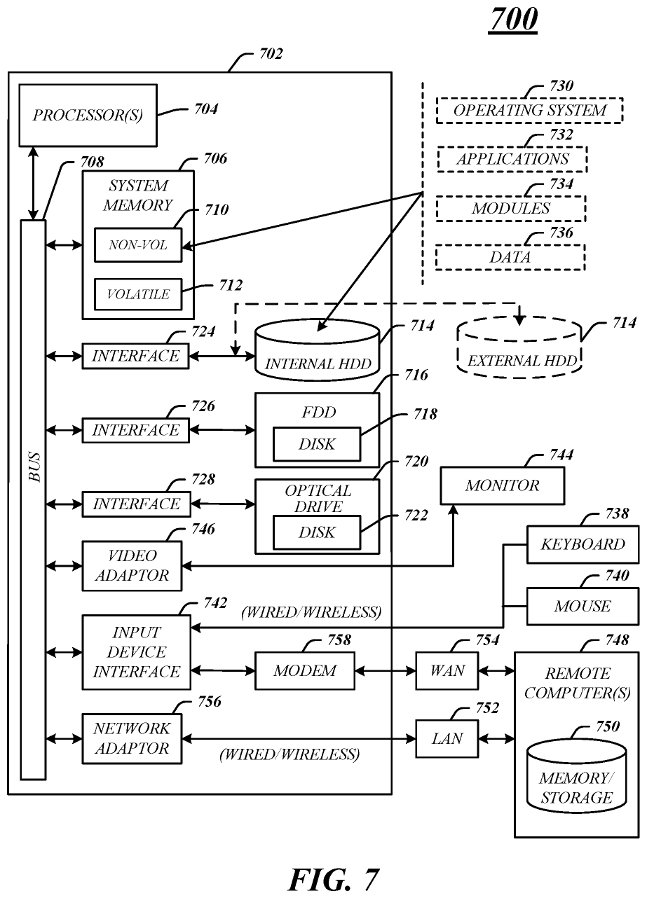

FIG. 7 illustrates an embodiment of an exemplary computing architecture 700, e.g., of a computing device, such as a desktop computer, laptop, tablet computer, mobile computer, smartphone, etc., suitable for implementing various embodiments as previously described. In one embodiment, the computing architecture 700 may include or be implemented as part of a system, which will be further described below. In examples, the computing device and/or the processing circuitries thereof may be configured to at least execute, support, provide, and/or access the various features and functionalities of the bias-removal platform 100 (e.g., the segmentation engine, the OCR engine, the biasing determination engine, the standardized template engine, etc.). In addition to the platform, it may be understood that the computing device and/or the processing circuitries may also be configured to perform, support, or execute any of the features, functionalities, descriptions described anywhere herein.

As used in this application, the terms “system” and “component” are intended to refer to a computer-related entity, either hardware, a combination of hardware and software, software, or software in execution, examples of which are provided by the exemplary computing architecture 700. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing architecture 700 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing architecture 700.

As shown in FIG. 7, the computing architecture 700 includes processor 704, a system memory 706 and a system bus 708. The processor 704 can be any of various commercially available processors, processing circuitry, central processing unit (CPU), a dedicated processor, a field-programmable gate array (FPGA), etc.

The system bus 708 provides an interface for system components including, but not limited to, the system memory 706 to the processor 704. The system bus 708 can be any of several types of bus structure that may further interconnect to a memory bus (with or without a memory controller), a peripheral bus, and a local bus using any of a variety of commercially available bus architectures. Interface adapters may connect to the system bus 708 via slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and the like.

The computing architecture 700 may include or implement various articles of manufacture. An article of manufacture may include a computer-readable storage medium to store logic. Examples of a computer-readable storage medium may include any tangible media capable of storing electronic data, including volatile memory or non-volatile memory, removable or non-removable memory, erasable or non-erasable memory, writeable or re-writeable memory, and so forth. Examples of logic may include executable computer program instructions implemented using any suitable type of code, such as source code, compiled code, interpreted code, executable code, static code, dynamic code, object-oriented code, visual code, and the like. Embodiments may also be at least partly implemented as instructions contained in or on a non-transitory computer-readable medium, which may be read and executed by one or more processors to enable performance of the operations described herein.

The system memory 706 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 7, the system memory 706 can include non-volatile memory 710 and/or volatile memory 712. A basic input/output system (BIOS) can be stored in the non-volatile memory 710.

The computer 702 may include various types of computer-readable storage media in the form of one or more lower speed memory units, including an internal (or external) hard disk drive (HDD) 714, a magnetic floppy disk drive (FDD) 716 to read from or write to a removable magnetic disk 718, and an optical disk drive 720 to read from or write to a removable optical disk 722 (e.g., a CD-ROM or DVD). The HDD 714, FDD 716 and optical disk drive 720 can be connected to the system bus 708 by a HDD interface 724, an FDD interface 726 and an optical drive interface 728, respectively. The HDD interface 724 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and memory units 710, 712, including an operating system 730, one or more application programs 732, other program modules 734, and program data 736. In one embodiment, the one or more application programs 732, other program modules 734, and program data 736 can include, for example, the various applications and/or components of the system 800.

A user can enter commands and information into the computer 702 through one or more wire/wireless input devices, for example, a keyboard 738 and a pointing device, such as a mouse 740. Other input devices may include microphones, infra-red (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, track pads, sensors, styluses, and the like. These and other input devices are often connected to the processor 704 through an input device interface 742 that is coupled to the system bus 708 but can be connected by other interfaces such as a parallel port, IEEE 1394 serial port, a game port, a USB port, an IR interface, and so forth.

A monitor 744 or other type of display device is also connected to the system bus 708 via an interface, such as a video adaptor 746. The monitor 744 may be internal or external to the computer 702. In addition to the monitor 744, a computer typically includes other peripheral output devices, such as speakers, printers, and so forth.

The computer 702 may operate in a networked environment using logical connections via wire and/or wireless communications to one or more remote computers, such as a remote computer 748. The remote computer 748 can be a workstation, a server computer, a router, a personal computer, portable computer, microprocessor-based entertainment appliance, a peer device or other common network node, and typically includes many or all the elements described relative to the computer 702, although, for purposes of brevity, only a memory/storage device 750 is illustrated. The logical connections depicted include wire/wireless connectivity to a local area network (LAN) 752 and/or larger networks, for example, a wide area network (WAN) 754. Such LAN and WAN networking environments are commonplace in offices and companies, and facilitate enterprise-wide computer networks, such as intranets, all of which may connect to a global communications network, for example, the Internet.

When used in a LAN networking environment, the computer 702 is connected to the LAN 752 through a wire and/or wireless communication network interface or adaptor 756. The adaptor 756 can facilitate wire and/or wireless communications to the LAN 752, which may also include a wireless access point disposed thereon for communicating with the wireless functionality of the adaptor 756.

When used in a WAN networking environment, the computer 702 can include a modem 758, or is connected to a communications server on the WAN 754 or has other means for establishing communications over the WAN 754, such as by way of the Internet. The modem 758, which can be internal or external and a wire and/or wireless device, connects to the system bus 708 via the input device interface 742. In a networked environment, program modules depicted relative to the computer 702, or portions thereof, can be stored in the remote memory/storage device 750. It will be appreciated that the network connections shown are exemplary and other means of establishing a communications link between the computers can be used.

The computer 702 is operable to communicate with wire and wireless devices or entities using the IEEE 802 family of standards, such as wireless devices operatively disposed in wireless communication (e.g., IEEE 802.11 over-the-air modulation techniques). This includes at least Wi-Fi (or Wireless Fidelity), WiMax, and Bluetooth™ wireless technologies, among others. Thus, the communication can be a predefined structure as with a conventional network or simply an ad hoc communication between at least two devices. Wi-Fi networks use radio technologies called IEEE 802.118 (a, b, g, n, etc.) to provide secure, reliable, fast wireless connectivity. A Wi-Fi network can be used to connect computers to each other, to the Internet, and to wire networks (which use IEEE 802.3-related media and functions).

The various elements of the devices as previously described with reference to FIGS. 1-6 may include various hardware elements, software elements, or a combination of both. Examples of hardware elements may include devices, logic devices, components, processors, microprocessors, circuits, processors, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

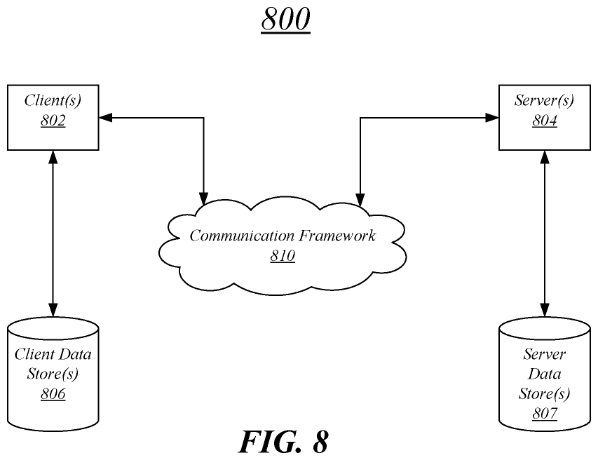

FIG. 8 is a block diagram depicting an exemplary communications architecture 800 suitable for implementing various embodiments. For example, one or more computing devices may communicate with each other via a communications framework, such as a network. At least one computing devices connected to the network may be a user computing device, such as a desktop computer, laptop, tablet computer, smartphone, etc. The user may be an employee within a company, or the user may be a customer of the company, or the like. At least a second computing device connected to the network may be one or more server computers, which may be implemented as a back-end server or a cloud-computing server. For example, the bias-removal platform may be provisioned on one or more back-end server computers. The user computing device may access the bias-removal platform via the communications framework.

The communications architecture 800 includes various common communications elements, such as a transmitter, receiver, transceiver, radio, network interface, baseband processor, antenna, amplifiers, filters, power supplies, and so forth. The embodiments, however, are not limited to implementation by the communications architecture 800.

As shown in FIG. 8, the communications architecture 800 includes one or more clients 802 and servers 804. The one or more clients 802 and the servers 804 are operatively connected to one or more respective client data stores 806 and server data stores 807 that can be employed to store information local to the respective clients 802 and servers 804, such as cookies and/or associated contextual information.

The clients 802 and the servers 804 may communicate information between each other using a communication framework 810. The communications framework 810 may implement any well-known communications techniques and protocols. The communications framework 810 may be implemented as a packet-switched network (e.g., public networks such as the Internet, private networks such as an enterprise intranet, and so forth), a circuit-switched network (e.g., the public switched telephone network), or a combination of a packet-switched network and a circuit-switched network (with suitable gateways and translators).

The communications framework 810 may implement various network interfaces arranged to accept, communicate, and connect to a communications network. A network interface may be regarded as a specialized form of an input/output (I/O) interface. Network interfaces may employ connection protocols including without limitation direct connect, Ethernet (e.g., thick, thin, twisted pair 10/100/1000 Base T, and the like), token ring, wireless network interfaces, cellular network interfaces, IEEE 802.7a-x network interfaces, IEEE 802.16 network interfaces, IEEE 802.20 network interfaces, and the like. Further, multiple network interfaces may be used to engage with various communications network types. For example, multiple network interfaces may be employed to allow for the communication over broadcast, multicast, and unicast networks. Should processing requirements dictate a greater amount speed and capacity, distributed network controller architectures may similarly be employed to pool, load balance, and otherwise increase the communicative bandwidth required by clients 802 and the servers 804. A communications network may be any one and the combination of wired and/or wireless networks including without limitation a direct interconnection, a secured custom connection, a private network (e.g., an enterprise intranet), a public network (e.g., the Internet), a Personal Area Network (PAN), a Local Area Network (LAN), a Metropolitan Area Network (MAN), an Operating Missions as Nodes on the Internet (OMNI), a Wide Area Network (WAN), a wireless network, a cellular network, and other communications networks.

The components and features of the devices described above may be implemented using any combination of discrete circuitry, application specific integrated circuits (ASICs), logic gates and/or single chip architectures. Further, the features of the devices may be implemented using microcontrollers, programmable logic arrays and/or microprocessors or any combination of the foregoing where suitably appropriate. It is noted that hardware, firmware and/or software elements may be collectively or individually referred to herein as “logic” or “circuit.”

At least one computer-readable storage medium may include instructions that, when executed, cause a system to perform any of the computer-implemented methods described herein.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Moreover, unless otherwise noted the features described above are recognized to be usable together in any combination. Thus, any features discussed separately may be employed in combination with each other unless it is noted that the features are incompatible with each other.

With general reference to notations and nomenclature used herein, the detailed descriptions herein may be presented in terms of program procedures executed on a computer or network of computers. These procedural descriptions and representations are used by those skilled in the art to most effectively convey the substance of their work to others skilled in the art.

A procedure is here, and generally, conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, the manipulations performed are often referred to in terms, such as adding or comparing, which are commonly associated with mental operations performed by a human operator. No such capability of a human operator is necessary, or desirable in most cases, in any of the operations described herein, which form part of one or more embodiments. Rather, the operations are machine operations.

Some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

Various embodiments also relate to apparatus or systems for performing these operations. This apparatus may be specially constructed for the required purpose and may be selectively activated or reconfigured by a computer program stored in the computer. The procedures presented herein are not inherently related to a particular computer or other apparatus. The required structure for a variety of these machines will appear from the description given.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

1. An apparatus comprising:
a memory to store instructions; and
processing circuitry, coupled with the memory, operable to execute the instructions, that when executed, cause the processing circuitry to:
segment one or more portions of a resume into one or more boxes, wherein the one or more boxes contain resume content;
perform optical character recognition (OCR) on the resume content in the one or more boxes;
identity any text in the resume content in the one or more boxes based at least in part on the performed OCR;
determine whether any of the identified text in the resume content in the one or more boxes includes a biasing term;
delete the biasing term or replace the biasing term with a non-biasing term; and
generate a modified resume based on a standardized resume template,
wherein the modified resume includes only the text and excludes at least the biasing term,
wherein the text is arranged according to an organization format specified in the standardized resume template
wherein the performance of the OCR comprises the processing circuitry to horizontally, vertically, and diagonally search the resume content in the one or more boxes, and
wherein the biasing term is determined via a classification model.

2. (canceled)

3. The apparatus of claim 1, wherein the organization format of the standardized resume template comprises a biography section, an education section, an experience section, an organizations section, a skills section.

4. The apparatus of claim 1, wherein the biasing term directly or indirectly indicates a gender and/or a race of a person associated with the resume.

5. The apparatus of claim 1, wherein the processing circuitry is further caused to:
identify any image in the resume content in the one or more boxes based on the performed OCR; and
exclude the image from the modified resume.

6. The apparatus of claim 1, wherein the processing circuitry is further caused to:
identify any color or color scheme in the resume content in the one or more boxes; and
exclude the color or the color scheme from the modified resume.

7. (canceled)

8. The apparatus of claim 1, wherein the classification model is a logistic regression model, a decision tree model, a random forest model, or a Bayes model.

9. The apparatus of claim 1, wherein the classification model is based on a convolutional neural network (CNN) algorithm, a recurrent neural network (RNN) algorithm, or a hierarchical attention network (HAN) algorithm.

10. The apparatus of claim 4, wherein the biasing term is a name of the person, a hobby associated with the gender of the person, or an organization associated with the gender.

11. The apparatus of claim 1, wherein the non-biasing term is a predefined generic term that describes the biasing term without directly or indirectly indicating the gender or the race of the person.

12. An apparatus, comprising:
a memory to store instructions; and
processing circuitry, coupled with the memory, operable to execute the instructions, that when executed, cause the processing circuitry to:
segment one or more portions of a resume into one or more boxes, wherein the one or more boxes contain resume content;
perform optical character recognition (OCR) on the resume content in the one or more boxes;
identity any text in the one or more boxes based at least in part on the performed OCR; and
generate a modified resume based on a standardized resume template, wherein the modified resume includes only text, and
wherein the performance of the OCR comprises the processing circuitry to horizontally, vertically, and diagonally search the resume content in the one or more boxes.

13. (canceled)

14. The apparatus of claim 12, wherein the text is arranged according to an organization format specified in the standardized resume template.

15. The apparatus of claim 14, wherein the organization format comprises a biography section, an education section, an experience section, an organizations section, and a skills section.

16. The apparatus of claim 12, wherein the processing circuitry is further caused to:
identify any image in the resume content in the one or more boxes; and
exclude the image from the modified resume.

17. An apparatus, comprising:
a memory to store instructions; and
processing circuitry, coupled with the memory, operable to execute the instructions, that when executed, cause the processing circuitry to:
segment one or more portions of a resume into one or more boxes, wherein the one or more boxes contain resume content;
perform optical character recognition (OCR) on the resume content in the one or more boxes;
identify any text in the one or more boxes based at least in part on the performed OCR;
determine whether any of the identified text in the one or more boxes includes a biasing term;
delete the biasing term or replace the biasing term with a non-biasing term; and
generate a modified resume, wherein the modified resume does not include any of the biasing terms,.
wherein the performance of the OCR comprises the processing circuitry to horizontally, vertically, and diagonally search the resume content in the one or more boxes, and
wherein the biasing term is determined via a classification model.

18. (canceled)

19. The apparatus of claim 17, wherein the classification model is a logistic regression model, a decision tree model, a random forest model, or a Bayes model.

20. The apparatus of claim 17, wherein the classification model is based on a convolutional neural network (CNN) algorithm, a recurrent neural network (RNN) algorithm, or a hierarchical attention network (HAN) algorithm.
